(19) United States
(12) Patent Application Publication
(10) Pub. No.: US 2024/0372159 A1
(43) Pub. Date: Nov. 7, 2024

(54) ELECTRICITY STORAGE DEVICE

(71) Applicant: DENSO CORPORATION, Kariya-city (JP)

(72) Inventors: Shuhei YOSHIDA, Kariya-city (JP); Hitoshi Onodera, Kariya-city (JP); Yuta Shimonishi, Kariya-city (JP)

(21) Appl. No.: 18/774,124

(22) Filed: Jul. 16, 2024

Related U.S. Application Data
(63) Continuation of application No. PCT/JP2023/000712, filed on Jan. 13, 2023.

(30) Foreign Application Priority Data
Jan. 19, 2022 (JP) 2022-006477

(51) Int. Cl. H01M 10/42; H01M 10/056

(52) U.S. Cl. CPC H01M 10/4235; H01M 10/056; H01M 2300/0085; H01M 2300/0091

(57) ABSTRACT

An electricity storage device includes a negative electrode, a positive electrode, a polymer electrolyte layer provided between the negative electrode and the positive electrode, an alloy-forming layer capable of forming a lithium alloy, and a polymer electrolyte layer having lithium ion conductivity. The polymer electrolyte layer has lithium ion conductivity. The polymer electrolyte layer and the alloy-forming layer are formed at least on a side of the negative electrode of the electrolyte layer. The alloy-forming layer is located closer to the electrolyte layer. The polymer electrolyte layer is located closer to the negative electrode.

### CROSS REFERENCE TO RELATED APPLICATIONS

The present application is a continuation application of International Patent Application No. PCT/JP2023/000712 filed on Jan. 13, 2023, which designated the U.S. and claims the benefit of priority from Japanese Patent Application No. 2022-006477 filed on Jan. 19, 2022. The entire disclosures of all of the above applications are incorporated herein by reference.

### TECHNICAL FIELD

The present disclosure relates to a chargeable and dischargeable electricity storage device.

### BACKGROUND

An electricity storage device is known to be charged and discharged by lithium ions moving between a positive electrode and a negative electrode.

### SUMMARY

According to at least one embodiment, an electricity storage device includes a negative electrode, a positive electrode, a polymer electrolyte layer provided between the negative electrode and the positive electrode, an alloy-forming layer capable of forming a lithium alloy, and a polymer electrolyte layer having lithium ion conductivity. The polymer electrolyte layer has lithium ion conductivity. The polymer electrolyte layer and the alloy-forming layer are formed at least on a side of the negative electrode of the electrolyte layer. The alloy-forming layer is located closer to the electrolyte layer. The polymer electrolyte layer is located closer to the negative electrode.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a cross-sectional view illustrating a configuration of an electricity storage device according to first and second embodiments.

FIG. 2 is a table illustrating a no-short-circuit current density of examples and comparative examples.

FIG. 3 is a table illustrating ionic conductivity of examples and comparative examples.

FIG. 4 is a cross-sectional view illustrating a configuration of an electricity storage device according to a third embodiment.

FIG. 5 is a cross-sectional view illustrating a configuration of an electricity storage device according to a fourth embodiment.

FIG. 6 is a cross-sectional view illustrating a configuration of an electricity storage device according to a fifth embodiment.

### DETAILED DESCRIPTION

To begin with, examples of relevant techniques will be described.

As an electricity storage device, lithium-ion batteries are known to be charged and discharged by lithium ions moving between a positive electrode and a negative electrode. In the lithium-ion batteries, repeated charging and discharging may cause lithium to deposit on a surface of the negative electrode, which may cause a short circuit between the electrodes. Furthermore, in lithium-ion batteries that use a negative electrode made of metallic lithium and a solid electrolyte layer, an interface between the negative electrode and the solid electrolyte layer acts as a nucleus for lithium precipitation, and the precipitated lithium grows along grain boundaries of the solid electrolyte, making them prone to short circuits.

A lithium-ion battery according to a comparative example has a solid electrolyte layer. The solid electrolyte layer is formed into two layers to reduce a short circuit between electrodes.

However, the lithium-ion battery has only a two-layer solid electrolyte layer, and is less effective at preventing a short circuit between electrodes.

In contrast to the comparative example, according to an electricity storage device of the present disclosures, a short circuit between electrodes can be reduced.

According to one aspect of the present disclosure, an electricity storage device includes a negative electrode, a positive electrode, a polymer electrolyte layer provided between the negative electrode and the positive electrode, an alloy-forming layer capable of forming a lithium alloy, and a polymer electrolyte layer having lithium ion conductivity. The polymer electrolyte layer has lithium ion conductivity. The polymer electrolyte layer and the alloy-forming layer are formed at least on a side of the negative electrode of the electrolyte layer. The alloy-forming layer is located closer to the electrolyte layer. The polymer electrolyte layer is located closer to the negative electrode.

According to this configuration, since the alloy-forming layer and the polymer electrolyte layer are formed at least on the side of the negative electrode, uniform lithium deposition reactions are capable of occurring on the electrode surface, and occurrence of localized lithium deposition reactions can be reduced, thereby reducing occurrence of short circuits.

Hereinafter, embodiments for implementing the present disclosure are described referring to drawings. In each embodiment, the same reference numerals may be given to parts corresponding to matters described in a preceding embodiment, and overlapping explanations may be omitted. When only a part of the configuration is described in each embodiment, the previously described other embodiments can be applied to other parts of the configuration. The present disclosure is not limited to combinations of embodiments which combine parts that are explicitly described as being combinable. As long as no problem is present, the various embodiments may be partially combined with each other even if not explicitly described.

### First Embodiment

A first embodiment of the present disclosure is described below with reference to the drawings. An electricity storage device 100 of the first embodiment is a secondary battery and is capable of storing and using electric energy. The electricity storage device 100 is a lithium-ion battery that is charged and discharged by a movement of lithium ions between a negative electrode 102 and a positive electrode 104.

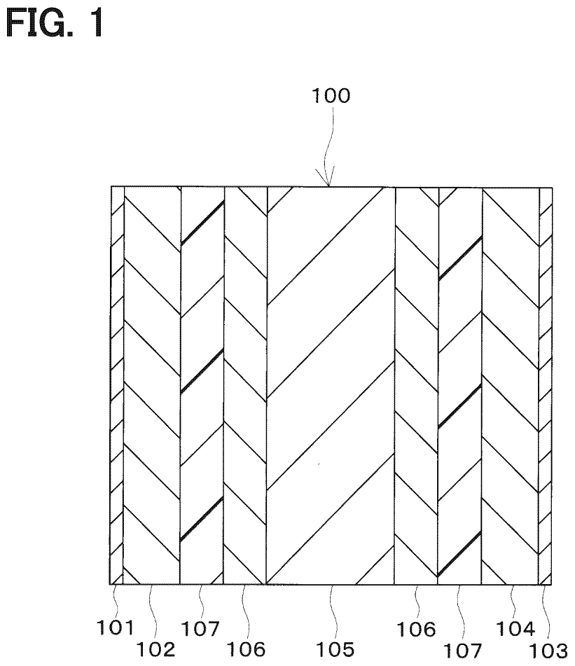

As shown in FIG. 1, the electricity storage device 100 includes a negative-electrode current collector 101, the negative electrode 102, a positive-electrode current collector 103, the positive electrode 104, and a solid electrolyte layer 105. Components of the electricity storage device 100, such as the negative-electrode current collector 101, are stacked.

The negative-electrode current collector 101 is connected to the negative electrode 102, and the positive-electrode current collector 103 is connected to the positive electrode 104. Any material that can be used as a current collector for a lithium-ion battery can be used for the negative-electrode current collector 101 and the positive-electrode current collector 103. In the present embodiment, copper (Cu) is used as the negative-electrode current collector 101, and aluminum (Al) is used as the positive-electrode current collector 103.

A negative electrode material constituting the negative electrode 102 can be any material that can be used as a negative electrode active material for lithium-ion batteries, such as a carbon-based negative electrode material, an oxide-based negative electrode material, or a metal-based negative electrode material. In the present embodiment, metallic lithium is used as the negative electrode material.

A positive electrode material constituting the positive electrode 104 can be any material that can be used as a positive electrode active material for lithium ion batteries. As the positive electrode 104, for example, a cobalt-based positive electrode material (LiCoO₂), a nickel-based positive electrode material (LiNiO₂), a manganese-based positive electrode material (LiMn₂₀₄), an iron phosphate-based positive electrode material (LiFePO₄), a ternary positive electrode material (NMC) mainly composed of nickel, manganese, and cobalt, and the like can be used.

The solid electrolyte layer 105 is made of a solid electrolyte having lithium ion conductivity. The solid electrolyte layer 105 can be made of any solid electrolyte that can be used as an electrolyte layer in a lithium-ion battery. As the solid electrolyte, for example, an oxide-based solid electrolyte or a sulfide-based solid electrolyte can be used. In the present embodiment, LLZO (Li₇La₃Zr₂O₁₂), which is the oxide-based solid electrolyte, is used as the solid electrolyte. The solid electrolyte layer 105 corresponds to an electrolyte layer of the present disclosure.

In the electricity storage device 100, an alloy-forming layer 106 capable of forming a lithium alloy, and a polymer electrolyte layer 107 having the lithium ion conductivity are provided on a surface of the solid electrolyte layer 105. The alloy-forming layer 106 and the polymer electrolyte layer 107 are provided as buffer layers for reducing occurrence of a short circuit in the electricity storage device 100. The alloy-forming layer 106 and the polymer electrolyte layer 107 of the present embodiment are provided between the negative electrode 102 and the solid electrolyte layer 105 and between the positive electrode 104 and the solid electrolyte layer 105.

Since lithium metal is likely to precipitate on a negative electrode side of a lithium-ion battery during charging and discharging, the alloy-forming layer 106 and the polymer electrolyte layer 107 may be formed at least on a surface of the solid electrolyte layer 105 facing the negative electrode. In the present embodiment, alloy-forming layers 106 and polymer electrolyte layers 107 are provided on both a surface facing the negative electrode and a surface facing the positive electrode of the solid electrolyte layer 105. The alloy-forming layers 106 provided on the negative electrode side and the positive electrode side have the same configuration, and the polymer electrolyte layers 107 provided on the negative electrode side and the positive electrode side have the same configuration.

The alloy-forming layer 106 and the polymer electrolyte layer 107 may have a multi-layer structure in which each layer is formed separately, or may have a mixed structure in which each layer is mixed and integrally formed. The alloy-forming layer 106 may be made up of two or more layers, and the polymer electrolyte layer 107 may be made up of two or more layers when the alloy-forming layer 106 and the polymer electrolyte layer 107 have a multi-layer structure. In the present embodiment, the multi-layer structure is formed in which one layer of each of the alloy-forming layer 106 and the polymer electrolyte layer 107 is formed.

In the present embodiment, of the alloy-forming layer 106 and the polymer electrolyte layer 107, the alloy-forming layer 106 is close to the solid electrolyte layer 105 and the polymer electrolyte layer 107 is far from the solid electrolyte layer 105.

A positional relationship between the alloy-forming layer 106 and the polymer electrolyte layer 107 is not particularly limited, but in order to exert short-circuit suppression effects of each layer, it is desirable that the alloy-forming layer 106 is close to the solid electrolyte layer 105 and the polymer electrolyte layer 107 is far from the solid electrolyte layer 105.

The alloy-forming layer 106 is a layer capable of forming a lithium alloy, and further has the lithium ion conductivity. In the alloy-forming layer 106, lithium alloying reaction interferes with a nucleation of lithium precipitation.

The alloy-forming layer 106 may be made of M_{X}N_{1-X}. “M” is a metal element, “N” is a nitrogen element, and X≤1.0. More specifically, the alloy-forming layer 106 may be made of a metal nitride such as CuN or TiN, or an elemental metal such as Ag or Au.

Lithium and the nitrogen contained in the metal nitride form an alloy to form LiN when the metal nitride is used as the alloy-forming layer 106. The simple metal and lithium form an alloy, for example, AgLi when the simple metal is used as the alloy-forming layer 106. LiN has high ionic conductivity and easily uniforms the current density, and therefore has a high short circuit suppression effect. Therefore, it is desirable to use a metal nitride as the alloy-forming layer 106.

The alloy-forming layer 106 may be formed in any manner. For example, the alloy-forming layer 106 can be formed on the surface of the solid electrolyte layer 105 by atomic layer deposition (ALD) or sputtering.

A thickness of the alloy-forming layer 106 is preferably 600 μm or less. When the thickness of the alloy-forming layer 106 exceeds 600 μm, the movement of lithium ions is hindered, resulting in a decrease in lithium ion conductivity. Moreover, it is desirable for the thickness of the alloy-forming layer 106 to be 200 μm or more. When the thickness of the alloy-forming layer 106 is less than 200 μm, it becomes difficult to form the alloy-forming layer 106 uniformly on the surface of the solid electrolyte layer 105, and durability is reduced.

The polymer electrolyte layer 107 has the lithium ion conductivity and is composed mainly of an ionic liquid of lithium salt and chain polyether. The chain polyether is a solvent. The polymer electrolyte layer 107 is also a low Young's modulus layer.

The Ionic liquid is liquid at room temperature and is liquid compounds consisting only of ions (anions and cations). Ionic liquids are non-volatile liquids with extremely low vapor pressure and relatively high ionic conductivity.

Lithium salt contained in the polymer electrolyte layer 107 can be at least one selected from LiN(SO₂F)₂, LiFSA, LiFSI, LiTFSI, Li((CF₂SO₂)₂N) and LiBF₄. By using these lithium salts, concentration of lithium salt in the polymer electrolyte layer 107 can be increased.

The chain polyether contained in the polymer electrolyte layer 107 is a polymer having an ether bond (—C—O—C—) in a main chain. As the chain polyether, for example, DEME (N,N-diethyl-N-methyl-N-(2-methoxyethyl) ammonium) or glymes can be used. As glymes, for example, G3 (tetraglyme) and G4 (triglyme) can be used.

The polymer electrolyte layer 107 can be formed by any method. For example, the polymer electrolyte layer 107 can be formed by applying a mixture of the above-mentioned lithium salt and chain polyether to the surface of the previously formed the alloy-forming layer 106.

By mixing the above-mentioned lithium salt with the chain polyether, a solvated ionic liquid is formed in which the chain polyether, which is the solvent, is coordinated to the lithium ions, and a gelled ionic liquid can be obtained. The higher the concentration of the lithium salt in the polymer electrolyte layer 107, the higher viscosity of the polymer electrolyte layer 107 can be made.

By using the lithium salt and chain polyether of the present embodiment, the concentration of the lithium salt in the polymer electrolyte layer 107 can be increased. In the present embodiment, the concentration of the lithium salt in the polymer electrolyte layer 107 is set to 3 M (mol/L) or more. The lithium salt concentration in the electrolyte used in a typical lithium-ion battery is about 1 to 1.5 M, whereas the lithium salt in the polymer electrolyte layer 107 of the present embodiment is made higher in concentration.

In the polymer electrolyte layer 107 of the present embodiment, the lithium salt is highly concentrated, so that the free solvent that is not coordinated with lithium ions can be reduced as much as possible. This can improve electrochemical stability of the polymer electrolyte layer 107 and can also improve ion transport number.

The polymer electrolyte layer 107 may be mixed with a solvent such as sulfolane or an ionic liquid such as [EMI][FSI], [EMI][FTI], [EMI][TFSI], or [BMI][TFSI]. As a result, the lithium salt in the polymer electrolyte layer 107 is capable of being a higher concentration.

Furthermore, additives such as a binder or a diluent, such as polyvinylidene fluoride (PVDF), may be added to the polymer electrolyte layer 107.

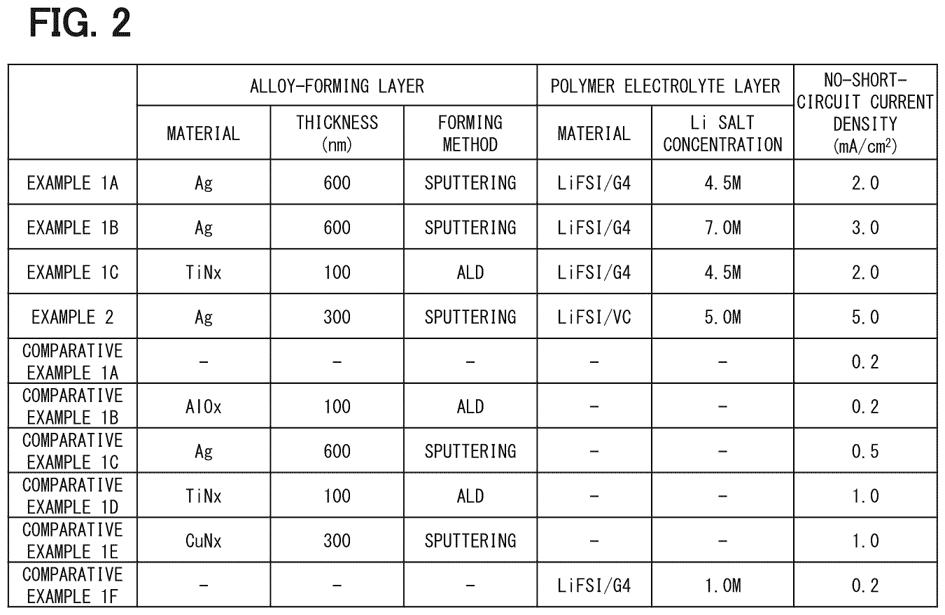

Results of a short-circuit resistance test performed on the electricity storage device 100 of the present embodiment will be described using an example and a comparative example shown in FIG. 2. In FIG. 2, examples 1A to 1C and comparative examples 1A to 1F correspond to the first embodiment. The example 2 corresponds to a second embodiment described later, and will be described in the second embodiment.

In Examples 1A to 1C, an electricity storage device in which an alloy-forming layer 106 and a polymer electrolyte layer 107 are formed is used. In Comparative Examples 1A to 1F, an electricity storage device in which at least one of the alloy-forming layer 106 and the polymer electrolyte layer 107 is not formed are used. In the electricity storage devices of Examples 1A to 1C and Comparative Examples 1A to 1F, metallic lithium is used as the negative electrode 102 and LLZO is used as the solid electrolyte layer 105. The thickness of the solid electrolyte layer 105 is 900 μm.

In Examples 1A, 1B, the alloy-forming layer 106 is formed by sputtering Ag to a thickness of 600 μm. In Example 1C, the alloy-forming layer 106 is formed by ALD using TiNx to a thickness of 100 μm. In Examples 1A to 1C, LiFSI (lithium salt) and G4 (chain polyether) are mixed and gelled for use as the polymer electrolyte layer 107. In Examples 1A, 1C, the lithium salt concentration in the polymer electrolyte layer 107 is set to 4.5 M, and in Example 1B, the lithium salt concentration in the polymer electrolyte layer 107 is set to 7.0 M.

In Comparative Example 1A, an electricity storage device in which neither the alloy-forming layer 106 nor the polymer electrolyte layer 107 is formed is used.

In Comparative Examples 1B to 1E, electricity storage devices in which the alloy-forming layer 106 is formed and the polymer electrolyte layer 107 is not formed is used. In Comparative Example 1B, AlOx is formed as the alloy-forming layer 106 to a thickness of 100 μm by ALD. In Comparative Example 1C, the alloy-forming layer 106 is formed by sputtering Ag to a thickness of 600 μm. In Example 1D, the alloy-forming layer 106 is formed by ALD using TiNx to a thickness of 100 μm. In Comparative Example 1E, CuNx is formed as the alloy-forming layer 106 to a thickness of 300 μm by ALD.

In Comparative Example 1F, an electricity storage device in which no alloy-forming layer 106 is formed and the polymer electrolyte layer 107 is formed is used. In Comparative Example 1F, a polymer electrolyte gelled by mixing LiFSI (lithium salt) and G4 (chain polyether) is used as the polymer electrolyte layer 107. In Comparative Example 1F, the lithium salt concentration in the polymer electrolyte layer 107 is set to 1.0 M.

In the short circuit resistance test, an HS cell (sealed bipolar cell) manufactured by Hohsen Corporation is used, and the electricity storage devices of the examples and comparative examples are assembled under a load of 5 kgf. Prior to the short circuit resistance test, an alternating current is passed through the electricity storage devices of the examples and comparative examples while they are heated to 60 degrees Celsius to ensure interface stability.

In the short circuit resistance test, the electricity storage devices of the examples and comparative examples are charged at an arbitrary current density for 30 minutes and then discharged three times. The current density is increased in the order of 0.02 mA/cm², 0.2 mA/cm², 0.5 mA/cm², 1.0 mA/cm², 1.5 mA/cm², 2.0 mA/cm² until a short circuit occurred. An upper limit of current density at which no short circuit occurred is determined as no-short-circuit current density.

As shown in FIG. 2, in Comparative Examples 1A to 1F, the no-short-circuit current density is 0.2 to 1.0 mA/cm². In the electricity storage devices of Comparative Examples 1A to 1F, the current density varied, and it is believed that repeated charging and discharging caused localized lithium deposition, resulting in a decrease in the no-short-circuit current density.

As shown in FIG. 2, in Examples 1A to 1C, high no-short-circuit current density values is 2.0 to 3.0 mA/cm². In the electricity storage devices of Examples 1A to 1C in which the alloy-forming layer 106 and the polymer electrolyte layer 107 are formed, a high short-circuit suppression effect is obtained.

In the electricity storage devices of Examples 1A to 1C, the nucleation of lithium precipitation is prevented by the lithium alloying reaction in the alloy-forming layer 106, and the current density is made uniform by the polymer electrolyte layer 107 having high ion conductivity. As a result, a uniform lithium deposition reaction is enabled during the charging and discharging of the electricity storage device, with occurrence of a local lithium deposition reaction reduced, and the effectiveness of the short-circuit suppression effect is increased.

It is believed that the metal nitride or elemental metal that constitutes the alloy-forming layer 106 diffuses to the lithium metal side that constitutes the electrode during charging and discharging, and a mixed ion/electron conductor interface having lithium ion conductivity and electronic conductivity is formed on the lithium metal surface. As a result, it is believed that the lithium deposition reaction occurs uniformly, which improves the effect of suppressing short circuits.

It is also believed that in the alloy-forming layer 106, lithium ions are conducted in a direction along the electrode surface due to lithium alloying, and the lithium ions move uniformly toward the electrode in the polymer electrolyte layer 107, which has a high ion transport number. As a result, it is believed that the lithium deposition reaction occurs uniformly, which improves the effect of suppressing short circuits.

In the present embodiment described above, the alloy-forming layer 106 capable of forming a lithium alloy and the polymer electrolyte layer 107 having lithium ion conductivity are provided on the surface of the solid electrolyte layer 105. As a result, the uniform lithium deposition reaction is capable of occurring on the electrode surface, and the occurrence of localized lithium deposition reaction can be reduced, thereby reducing the occurrence of short circuits.

Furthermore, the electricity storage device 100 of the present embodiment is configured using the negative electrode 102 made of lithium metal and the solid electrolyte layer 105, and is prone to short circuits. Therefore, by forming the alloy-forming layer 106 and the polymer electrolyte layer 107 on the surface of the solid electrolyte layer 105, the short-circuit suppression effect can be more effectively obtained.

Furthermore, the alloy-forming layer 106 fluctuates in volume due to alloying reactions with charging and discharging. Since the polymer electrolyte layer 107 of the present embodiment is a low Young's modulus layer, the polymer electrolyte layer 107 is capable of absorbing the volumetric fluctuation of the alloy-forming layer 106. As a result, the electricity storage device 100 can be used stably and continuously when the electricity storage device is repeatedly charged and discharged.

In the present embodiment, the polymer electrolyte layer 107 uses a polymer electrolyte having the lithium salt concentration of 3 M or more. As a result, the electrochemical stability and the ion transport number can be improved.

Furthermore, in the electricity storage device 100 of the present embodiment, since the polymer electrolyte layer 107 is in a gel state, the polymer electrolyte layer 107 is less likely to volatilize. Therefore, the electricity storage device 100 of the present embodiment can be suitably used in applications where there are large variations in air pressure, such as eVTOLs (electric vertical take-off and landing aircraft) and submarines.

### Second Embodiment

Next, a second embodiment of the present disclosure is described. Hereinafter, only portions different from the first embodiment will be described.

An electricity storage device 100 of the second embodiment has a configuration similar to that of the first embodiment described above with reference to FIG. 1, and includes a negative-electrode current collector 101, a negative electrode 102, a positive-electrode current collector 103, a positive electrode 104, a solid electrolyte layer 105, an alloy-forming layer 106, and a polymer electrolyte layer 107. In the second embodiment, a solvent of a polymer electrolyte constituting the polymer electrolyte layer 107 is different from that in the first embodiment. In the second embodiment, a chain polycarbonate and a cyclic polycarbonate are used as the solvent for the polymer electrolyte. Lithium salt of the polymer electrolyte may be the same as that of the first embodiment.

The chain polycarbonate and the cyclic polycarbonate are main components of the polymer electrolyte, and account for 50% by weight or more of the polymer electrolyte. The polymer electrolyte may contain at least a chain polycarbonate. The polymer electrolyte may contain additives such as a binder and a diluent.

The chain polycarbonate and the cyclic polycarbonate can be produced by polymerizing cyclic monomers with a dielectric constant of 80 or greater. Cyclic monomers having a relative dielectric constant of 80 or more tend to open the ring during polymerization to produce chain polymers.

In the second embodiment, vinylene carbonate (VC) is used as the cyclic monomer having a relative dielectric constant of 80 or more. For this reason, the chain polycarbonate and the cyclic polycarbonate are obtained as polymers derived from vinylene carbonate. The polymer electrolyte of the second embodiment contains polycarbonate produced by polymerization of vinylene carbonate and decomposition products produced from non-polymerized vinylene carbonate. Hereinafter, the polymer derived from vinylene carbonate is also referred to as “VC polymer”.

The polymer electrolyte of the second embodiment can be obtained by adding a polymerization initiator to a mixture of a lithium salt and vinylene carbonate, and then heating or irradiating the mixture with ultraviolet light. The polymerization initiator may be any one that is soluble in the solvent, and the polymerization may be used include azobisisobutyronitrile (AIBN), benzoyl peroxide (BPO), and cumene hydroperoxide. The polymerization initiator may be added in an amount of about 1 mg per 1 ml of vinylene carbonate.

A ring-opening reaction of vinylene carbonate occurs to produce chain polycarbonate when vinylene carbonate is polymerized. A portion of the vinylene carbonate does not undergo the ring opening, resulting in a production of cyclic polycarbonate when vinylene carbonate is polymerized. Therefore, the polymer electrolyte of the second embodiment contains chain polycarbonates and cyclic polycarbonates.

In the polymer electrolyte of the second embodiment, the chain polycarbonate improves electrostatic force with the lithium ions, so that the concentration of the lithium salt can be improved. In the second embodiment, the concentration of the lithium salt in the polymer electrolyte layer 107 is set to 3 M (mol/L) or more.

Moreover, in the polymer electrolyte of the second embodiment, high ionic conductivity is obtained. In a typical polymer electrolyte, the ionic conductivity in the room temperature range is about 10⁻⁵ S/cm, whereas in the polymer electrolyte of the second embodiment, the ionic conductivity in the room temperature range is about 10-3 S/cm.

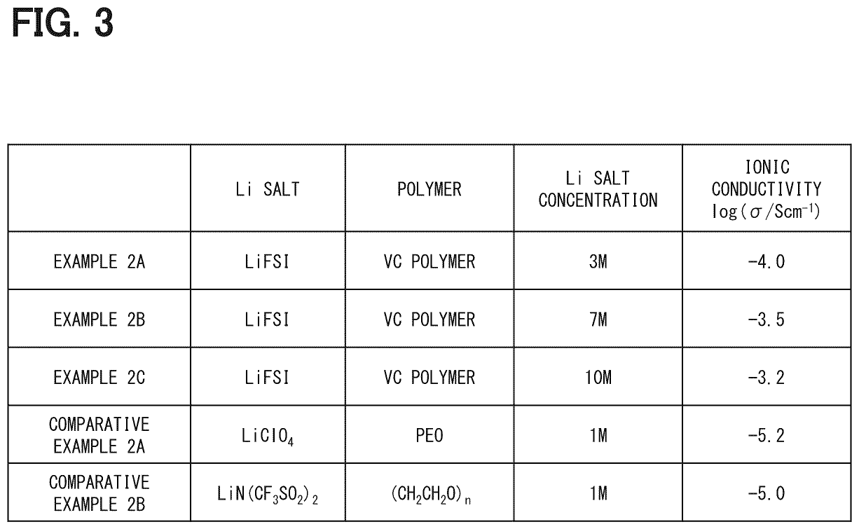

Here, the ionic conductivity of the electricity storage device 100 of the second embodiment will be described with reference to examples and comparative examples shown in FIG. 3. The ionic conductivity in FIG. 3 is a value measured in the room temperature range, and the measured value is shown in logarithm.

In Examples 2A to 2C, the polymer electrolyte is obtained using LiFSI as the lithium salt and VC polymer as the solvent. In Comparative Example 2A, LiClO₄ is used as the lithium salt and polyethylene oxide (PEO) is used as the solvent to obtain a polymer electrolyte. In Comparative Example 2B, LiN(CF₃CO₂)₂ is used as the lithium salt and ethylene oxide (CH₂CH₂O)ₙ is used as the solvent to obtain a polymer electrolyte.

In Example 2A, the lithium salt concentration is 3 M, in Example 2B, the lithium salt concentration is 7 M, and in Example 2C, the lithium salt concentration is 10 M. In Comparative Examples 2A, 2B, the lithium salt concentration is 1 M. In Examples 2A to 2C, higher lithium salt concentrations are obtained than in Comparative Examples 2A, 2B.

As shown in FIG. 3, the ionic conductivity of Comparative Example 2A is −5.2, and the ionic conductivity of Comparative Example 2B is −5.0. Contrary to this, the ionic conductivity of Example 2A is −4.0, the ionic conductivity of Example 2B is −3.5, and the ionic conductivity of Example 2C is −3.2. The electricity storage devices of Examples 2A to 2C have a significantly improved ionic conductivity compared to the electricity storage devices of Comparative Examples 2A, 2B. Furthermore, in the electricity storage devices 100 of Examples 2A to 2C, the higher the lithium salt concentration, the higher the ionic conductivity obtained.

Next, results of a short-circuit resistance test performed on the electricity storage device 100 of the second embodiment will be described with reference to Example 2 in FIG. 2. The short-circuit resistance test of Example 2 is the same as the short-circuit resistance test described in the first embodiment with reference to FIG. 2.

In Example 2, the alloy-forming layer 106 is formed by sputtering Ag to a thickness of 300 μm. In Example 2, a mixed solution of LiFSI (lithium salt), vinylene carbonate (solvent), and azobisisobutyronitrile (polymerization initiator) is heated to 60 degrees Celsius to polymerize, thereby obtaining a polymer electrolyte. In Example 2, the lithium salt concentration of the polymer electrolyte is set to 5.0 M. In Example 2, the no-short-circuit current density is 5.0 mA/cm², which is a higher value than Examples 1A to 1C of the first embodiment.

In the second embodiment described above, the polymer electrolyte layer 107 contains the chain polycarbonate and the cyclic polycarbonate, and the concentration of the lithium salt in the polymer electrolyte layer 107 is set to 3 M or more. By including the chain polycarbonate in the polymer electrolyte layer 107, the lithium salt can be effectively concentrated, and the ionic conductivity can be improved. As a result, a uniform lithium deposition reaction is capable of occurring on the electrode surface, and the occurrence of short circuits can be more effectively reduced.

### Third Embodiment

Next, a third embodiment of the present disclosure is described. Hereinafter, only portions different from the above embodiments will be described.

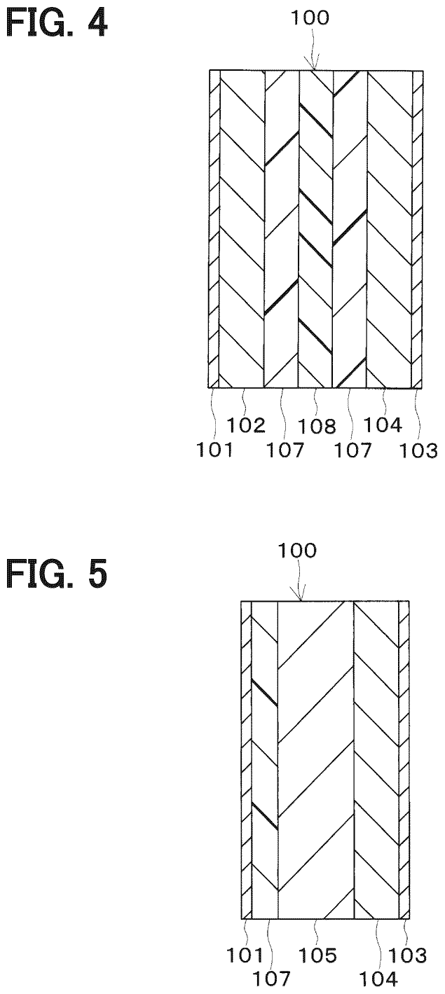

As shown in FIG. 4, an electricity storage device 100 of the third embodiment includes a negative-electrode current collector 101, a negative electrode 102, a positive-electrode current collector 103, a positive electrode 104, a polymer electrolyte layer 107, and a separator 108. In the electricity storage device 100 of the third embodiment, a solid electrolyte layer 105 and an alloy-forming layer 106 are not provided.

The separator 108 has a pore structure, and has a function of separating the negative electrode 102 and the positive electrode 104 and allowing ions to pass therethrough. The separator 108 may be made of, for example, polypropylene, polyethylene, nonwoven fabric, or the like.

In the third embodiment, similarly to the second embodiment, the polymer electrolyte layer 107 uses a chain polycarbonate and a cyclic polycarbonate as main components. More specifically, a VC polymer derived from vinylene carbonate is used.

In FIG. 4, for convenience, the separator 108 and the polymer electrolyte layer 107 are shown separately, but in reality, the separator 108 and the polymer electrolyte layer 107 are provided integrally. More specifically, the polymer electrolyte layer 107 is provided by being impregnated into pores of the separator 108.

In the electricity storage device 100 according to the third embodiment described above, a uniform lithium deposition reaction is capable of occurring on the electrode surface, and the occurrence of short circuits can be more effectively reduced.

In addition, in the third embodiment, the polymer electrolyte layer 107 is provided by impregnating the pores of the separator 108, but this is not limiting, and the polymer electrolyte layer 107 may be provided by applying the polymer electrolyte layer 107 to the electrode surface.

### Fourth Embodiment

Next, a fourth embodiment of the present disclosure is described. Hereinafter, only portions different from the above embodiments will be described.

As shown in FIG. 5, an electricity storage device 100 of the fourth embodiment includes a negative-electrode current collector 101, a positive-electrode current collector 103, a positive electrode 104, a solid electrolyte layer 105, and a polymer electrolyte layer 107. In the electricity storage device 100 of the fourth embodiment, a negative electrode 102 and an alloy-forming layer 106 are not provided.

In the fourth embodiment, similarly to the second embodiment, the polymer electrolyte layer 107 uses a chain polycarbonate and a cyclic polycarbonate as main components. More specifically, a VC polymer derived from vinylene carbonate is used.

In the fourth embodiment, the polymer electrolyte layer 107 is provided on the negative-electrode current collector 101 side of the solid electrolyte layer 105.

In FIG. 5, for convenience, the solid electrolyte layer 105 and the polymer electrolyte layer 107 are shown separately, but in reality, the solid electrolyte layer 105 and the polymer electrolyte layer 107 are provided integrally. The solid electrolyte layer 105 is a porous body, and the polymer electrolyte layer 107 is in a state of penetrating into pores of the solid electrolyte layer 105 on the negative-electrode current collector 101 side.

The electricity storage device 100 of the fourth embodiment is configured as an anode-free battery in which the negative electrode 102 is not formed on the negative-electrode current collector 101 in an initial state. In the anode-free battery, lithium metal is deposited on a negative-electrode current collector 101 by lithium ions that migrate from the positive electrode 104 during charging to form the negative electrode 102. During discharge, the lithium metal constituting the negative electrode 102 migrates to the positive electrode 104 as lithium ions.

In the electricity storage device 100 according to the fourth embodiment described above, a uniform lithium deposition reaction is capable of occurring on the electrode surface, and the occurrence of short circuits can be more effectively reduced.

### Fifth Embodiment

Next, a fifth embodiment of the present disclosure is described. Hereinafter, only portions different from the above embodiments will be described.

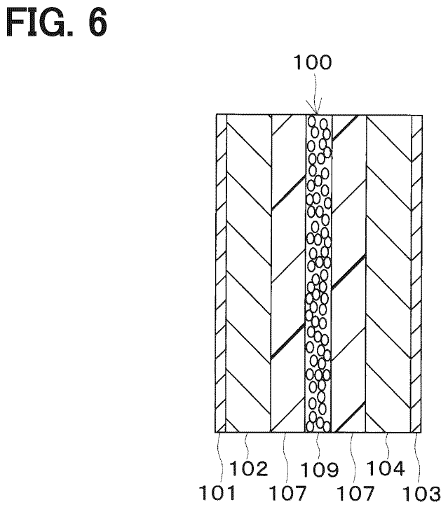

As shown in FIG. 6, an electricity storage device 100 of the fifth embodiment includes a negative-electrode current collector 101, a negative electrode 102, a positive-electrode current collector 103, a positive electrode 104, a polymer electrolyte layer 107, and a base membrane 109. The polymer electrolyte layer 107 is provided so as to cover both surfaces of the base membrane 109.

In the fifth embodiment, similarly to the second embodiment, the polymer electrolyte layer 107 uses a chain polycarbonate and a cyclic polycarbonate as main components. More specifically, a VC polymer derived from vinylene carbonate is used.

The base membrane 109 is a film-like member. The base membrane 109 can be formed using at least one of the material constituting the solid electrolyte layer 105 and the material constituting the alloy-forming layer 106. The base membrane 109 may be formed by powdering the materials constituting the solid electrolyte layer 105 and the alloy-forming layer 106 into a film-like member.

In the electricity storage device 100 according to the fifth embodiment described above, a uniform lithium deposition reaction is capable of occurring on the electrode surface, and the occurrence of short circuits can be more effectively reduced.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An electricity storage device comprising:
a negative electrode;
a positive electrode;
an electrolyte layer provided between the negative electrode and the positive electrode and having lithium ion conductivity;
an alloy-forming layer capable of forming an alloy with lithium; and
a polymer electrolyte layer having lithium ion conductivity, wherein
the polymer electrolyte layer and the alloy-forming layer are formed at least on a side of the negative electrode of the electrolyte layer,
the alloy-forming layer is located closer to the electrolyte layer, and
the polymer electrolyte layer is located closer to the negative electrode.

2. An electricity storage device comprising:
a negative electrode;
a positive electrode;
an electrolyte layer provided between the negative electrode and the positive electrode and having lithium ion conductivity;
an alloy-forming layer capable of forming an alloy with lithium; and
a polymer electrolyte layer having lithium ion conductivity, wherein
the polymer electrolyte layer and the alloy-forming layer are formed at least on a side of the negative electrode of the electrolyte layer,
the alloy-forming layer and the polymer electrolyte layer are mixed and integrally formed and have a mixed structure.

3. The electricity storage device according to claim 1, wherein
the alloy-forming layer contains a metal nitride.

4. The electricity storage device according to claim 1, wherein
the alloy-forming layer has a thickness of 600 nm or less.

5. The electricity storage device according to claim 1, wherein
the polymer electrolyte layer contains lithium salt, and
concentration of the lithium salt in the polymer electrolyte layer is 3 mol/L or more.

6. The electricity storage device according to claim 1, wherein
the polymer electrolyte layer contains ionic liquid of lithium salt and chain polyether.

7. The electricity storage device according to claim 5, wherein
the lithium salt is at least one selected from a group consisting of LiN(SO₂F)₂, LiFSA, LiFSI, LiTFSI, Li((CF₂SO₂)₂N) and LiBF₄.

8. The electricity storage device according to claim 1, wherein
the electrolyte layer is made of solid electrolyte.

9. The electricity storage device according to claim 1, wherein
the negative electrode contains Li metal.

10. The electricity storage device according to claim 1, wherein
the alloy-forming layer is located closer to the electrolyte layer than the polymer electrolyte layer, and
the polymer electrolyte layer is located closer to the negative electrode than the alloy-forming layer.
